(19) United States
(12) Patent Application Publication
(10) Pub. No.: US 2025/0388736 A1
(43) Pub. Date: Dec. 25, 2025

(54) RESIN COMPOSITION FOR OPTICAL CONNECTION COMPONENT, MT FERRULE, AND METHOD FOR MANUFACTURING RESIN COMPOSITION FOR OPTICAL CONNECTION COMPONENT

(71) Applicant: Lightera Japan Co., Ltd., Tokyo (JP)

(72) Inventors: Takahiro MIURA, Tokyo (JP); Takanori YAMAZAKI, Tokyo (JP); Masayoshi TSUKAMOTO, Tokyo (JP); Masahiro HANDA, Tokyo (JP); Toshihito KORESAWA, Tokyo (JP)

(73) Assignee: Lightera Japan Co., Ltd., Tokyo (JP)

(21) Appl. No.: 19/241,744

(22) Filed: Jun. 18, 2025

(30) Foreign Application Priority Data
Jun. 24, 2024 (JP) 2024-101293

(51) Int. Cl. C08K 3/36; B29C 45/00; B29C 45/46; B29D 11/00; B29K 81/00; B29K 509/08; G02B 6/38

(52) U.S. Cl. CPC C08K 3/36; B29C 45/0001; B29C 45/0013; B29C 45/46; G02B 6/3865; B29D 11/0075; B29K 2081/04; B29K 2509/08; B29K 2995/0012; B29K 2995/0041; B29K 2995/007; C08K 2201/005; C08K 2201/019

(57) ABSTRACT

The present invention intends to provide a resin composition for an optical connection component capable of achieving both suppression of loss fluctuation due to temperature increase and satisfactory PC connection. The resin composition for an optical connection component includes a base resin and an inorganic filler. A glass transition temperature of the base resin is higher than or equal to 85° C. A mass of a residue obtained by heating the resin composition for the optical connection component at 700° C. is greater than or equal to 68.0% and less than or equal to 74.4% with respect to a mass of the resin composition for the optical connection component. A Rockwell hardness of the resin composition for the optical connection component is greater than or equal to 97.1 and less than or equal to 106.8.

### BACKGROUND OF THE INVENTION

### Field of the Invention

The present invention relates to a resin composition for an optical connection component, an MT ferrule, and a method for manufacturing a resin composition for an optical connection component.

### Description of the Related Art

Optical connection components for connecting optical fibers are known. The optical connection component is provided with an optical fiber insertion hole and a guide pin insertion hole. The end face of the optical fiber is fixed by inserting the optical fiber into the optical fiber insertion hole. By inserting the guide pins of the other optical connection components into the guide pin insertion holes of the optical connection components, the optical connection components are connected to each other such that the end surfaces of the optical fibers face each other. Thus, a physical contact (PC) connection between the optical fibers is realized.

When the optical connection component deforms due to the temperature increase, the position of the optical fiber end face is shifted, and the connection loss of the optical connection component fluctuates. In order to suppress a fluctuation in connection loss due to a temperature increase, a technique of incorporating an inorganic filler into a resin composition for an optical connection component is known. The resin composition for an optical connection component disclosed in Japanese Patent Application Laid-Open No. 2004-29415, includes 80 to 90 wt % of spherical silica fine particles to reduce the connection loss of the optical connection component due to temperature increase.

### SUMMARY OF THE INVENTION

However, when the content of the inorganic filler is too large, the rigidity of the optical connection component becomes too high, and the resistance at the time of inserting the guide pin into the guide pin insertion hole becomes large. In this case, the end faces of the optical fibers cannot be sufficiently close to each other, and the PC connection may be deteriorated. Therefore, it may be difficult to achieve both suppression of loss fluctuation due to temperature increase and favorable PC connection.

An object of the present invention is to provide a resin composition for an optical connection component capable of achieving both suppression of loss fluctuation due to temperature increase and satisfactory PC connection.

According to one aspect of the present invention, provided is a resin composition for an optical connection component including a base resin and an inorganic filler. A glass transition temperature of the base resin is higher than or equal to 85° C. A mass of a residue obtained by heating the resin composition for the optical connection component at 700° C. is greater than or equal to 68.0% and less than or equal to 74.4% with respect to a mass of the resin composition for the optical connection component. A Rockwell hardness of the resin composition for the optical connection component is greater than or equal to 97.1 and less than or equal to 106.8.

According to another aspect of the present invention, provided is a method for manufacturing a resin composition for an optical connection component including a first step for mixing a base resin and an inorganic filler and a second step for injection-molding a mixture obtained in the first step. A glass transition temperature of the base resin is higher than or equal to 85° C. A mass of a residue obtained by heating the resin composition for the optical connection component at 700° C. is greater than or equal to 68.0% and less than or equal to 74.4% with respect to a mass of the resin composition for the optical connection component. A Rockwell hardness of the resin composition for the optical connection component is greater than or equal to 97.1 and less than or equal to 106.8.

According to the present invention, it is possible to provide a resin composition for an optical connection component capable of achieving both suppression of loss fluctuation due to temperature increase and satisfactory PC connection.

### BRIEF DESCRIPTION OF THE DRAWINGS

FIG. 1 is an external view of a ferrule according to an embodiment of the present invention.

FIG. 2 is a flowchart illustrating a method for manufacturing the ferrule according to one embodiment of the present invention.

### DESCRIPTION OF THE EMBODIMENTS

Hereinafter, embodiments according to the present invention will be described in detail with reference to the drawings. Throughout the drawings, components having the same functions are labeled with the same references, and the repetitive description may be omitted or simplified.

A resin composition (a resin composition for an optical connection component) according to an embodiment of the present invention will be described by taking a ferrule (an optical connection component) used for a connector of an optical fiber as an example.

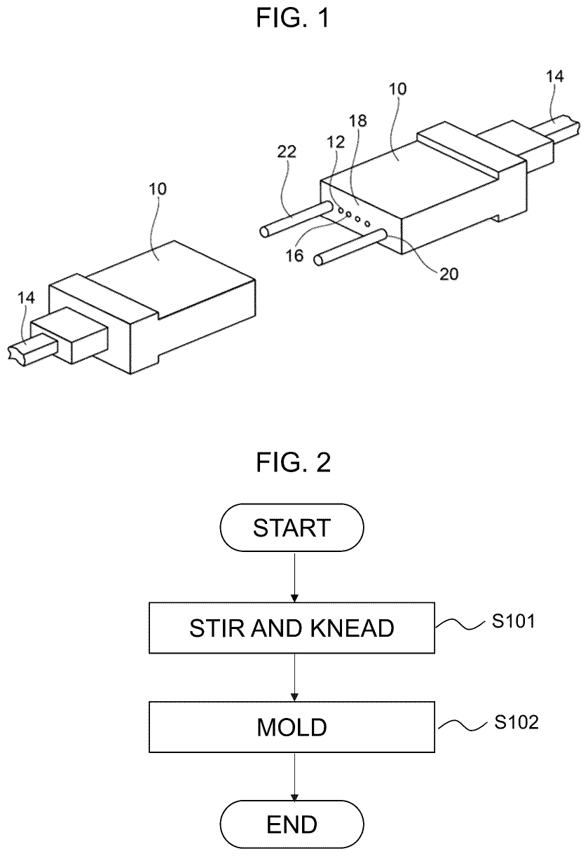

FIG. 1 is an external view of a ferrule according to the present embodiment. The ferrule is used as an optical connector for optically connecting optical fibers. FIG. 1 illustrates a ferrule of a mechanically transferable (MT) connector, but the ferrule according to the present embodiment may be a multifiber push-on (MPO) connector or the like.

As illustrated in FIG. 1, the ferrule 10 has a substantially rectangular parallelepiped shape, and a plurality of optical fiber insertion holes 12 are formed in an end surface 18 of the ferrule 10. The coated optical fiber 14 includes a plurality of optical fibers 16, and the optical fibers 16 are inserted into the optical fiber insertion holes 12 respectively and fixed by an adhesive or the like. The end surface 18 is polished by, for example, physical contact (PC) polishing, super PC (SPC) polishing, ultra PC (UPC) polishing, angled PC (APC) polishing, or the like. Thus, the optical fibers can protrude from the end surface 18, and the optical fibers 16 can be connected to each other.

The ferrule 10 does not necessarily have to be provided with a plurality of optical fiber insertion holes 12. When the coated optical fiber 14 is a single fiber core including a single optical fiber 16, a single optical fiber insertion hole 12 is formed in the ferrule 10.

The ferrule 10 is further formed with a pair of guide pin insertion holes 20. The pair of guide pin insertion holes 20 are formed in the ferrule 10 so as to be located on both sides of the plurality of optical fiber insertion holes 12. The pair of guide pin insertion holes 20 are formed in the ferrule 10 along the connecting direction of the optical fiber 16. A guide pin 22 for alignment is inserted into each of the pair of guide pin insertion holes 20.

The guide pins 22 are inserted into the respective guide pin insertion holes 20 of the pair of ferrules 10, and the two ferrules 10 are aligned. The two end faces of the optical fiber 16 are in contact with each other, and the two ferrules 10 are fixed by a fixing jig such as a clip. As a result, the optical fibers 16 are connected. A configuration of aligning and fixing the two ferrules 10 is not limited thereto. The two ferrules 10 may be aligned and fixed through, for example, an adapter.

Next, the resin composition used in the ferrule will be described. The resin composition is injected into a mold to manufacture a ferrule 10 as an injection molded article.

The resin composition in the present embodiment includes a base resin and an inorganic filler. Hereinafter, the base resin and the inorganic filler will be described in detail. The resin composition may further include a colorant such as carbon black and a silane coupling agent.

### [Base Resin]

The base resin is a matrix resin constituting the continuous phase of the ferrule 10. The base resin may be a thermoplastic resin or a thermosetting resin. When the base resin is a thermoplastic resin, examples of the base resin include polyarylene sulfide, polyphenylene sulfide (PPS) resin, polyether ether ketone (PEEK) resin, polystyrene (PS) resin, polymethyl methacrylate (PMMA) resin, polycarbonate (PC) resin, polysulfone (PSU) resin, and polyimide (PI) resin. When the base resin is a thermosetting resin, the base resin is, for example, an epoxy resin.

From the viewpoint of fluidity of the resin composition, the base resin is preferably a PPS resin. The PPS resin may be a linear PPS resin, a semi-linear (semi-crosslinked) PPS resin, or a crosslinked PPS resin.

The base resin is not limited to one type of resin, and may be composed of a plurality of types of resins. For example, the base resin may include a PPS resin and a PEEK resin. Further, the base resin may include resins of different grades of the same type of resin. For example, the base resin may include a semi-linear PPS resin and a crosslinked PPS resin. The structure and molecular weight of the base resin are appropriately selected according to the characteristics required for the ferrule 10.

The glass transition temperature of the base resin is preferably higher than or equal to 85° C. When the glass transition temperature of the base resin is lower than 85° C., the optical connection component may be softened under a temperature condition of higher than or equal to 85° C. When the base resin is a thermoplastic resin, the base resin is preferably a crystalline polymer. By selecting a crystalline polymer as the base resin, it is possible to lower the softening rate under a high temperature condition than the glass transition temperature. As a result, it is possible to effectively suppress the fluctuation of the connection loss of the optical connection component due to the temperature increase.

### [Inorganic Filler]

The inorganic filler is included in the resin composition for the purpose of reducing the molding shrinkage ratio of the ferrule 10, reducing the linear thermal expansion coefficient of the ferrule 10, improving the dimensional accuracy of the ferrule 10, and the like. The inorganic filler has a small linear thermal expansion coefficient and a high hardness. Since silica has a low linear thermal expansion coefficient and a high hardness, the inorganic filler is preferably silica.

The inorganic filler is not limited to one type of inorganic material, and may be composed of a plurality of types of inorganic materials. For example, the inorganic material may include silica and calcium carbonate.

The silica may be spherical silica, amorphous silica, or a mixture of spherical silica and amorphous silica. The spherical silica is a spherical or ellipsoidal silica. The spherical silica is manufactured by, for example, a flame fusion method. In the flame fusion method, first, natural squash or quartz crystal is pulverized by a ball mill or the like, and the pulverized product is sprayed into an LPG-oxygen flame. The sprayed individual fine particles are melted and liquefied and spheroidized by surface tension to obtain spherical silica.

The amorphous silica is a polygonal silica and is also referred to as crushed silica. The surface of the amorphous silica has complex unevenness. The amorphous silica may be crystalline amorphous silica or fused amorphous silica. The crystalline amorphous silica is obtained by pulverizing natural silica and adjusting the pulverized product to a predetermined particle size distribution. The fused amorphous silica is obtained by melting and grinding natural silica.

The silica is preferably spherical silica. Spherical silica has a small specific surface area as compared with amorphous silica, and thus the viscosity of the resin composition is low. Therefore, injection molding of the resin composition can be easily performed.

The cumulative 100% particle diameter D₁₀₀ of the inorganic filler is preferably less than or equal to 98.4 μm. The cumulative 100% particle diameter D₁₀₀ of the inorganic filler is more preferably less than or equal to 40.2 μm. The cumulative 100% particle diameter D₁₀₀ is a particle diameter at which the accumulation of small particle diameters is 100% in the cumulative particle diameter distribution curve based on volume. In the polishing of the optical connection component, the polishing material and the inorganic filler come into contact with each other while the polishing material penetrates into the base resin, whereby the resin composition is efficiently polished. When the particle diameter of the inorganic filler is increased, the probability that the polishing material comes into contact with the inorganic filler is decreased, and the polishing efficiency of the resin composition may be decreased.

The cumulative 50% particle diameter D₅₀ of the inorganic filler is preferably greater than or equal to 1.4 μm and less than or equal to 16.0 μm. The cumulative 50% particle diameter Dso is a particle diameter at which the accumulation of small particle diameters is 50% in the cumulative particle diameter distribution curve based on volume. When the cumulative 50% particle diameter D₅₀ of the inorganic filler is greater than 16.0 μm, the linear thermal expansion coefficient of the optical connection component becomes ununiform, and the dimensional accuracy of the optical connection component may be lowered. When the cumulative 50% particle diameter D₅₀ of the inorganic filler is less than 1.4 μm, the melt viscosity of the resin composition increases and the fluidity of the resin composition decreases. As a result, in particular, when a thin optical connection component is manufactured, unfilling of the resin composition may occur, and sink marks of the optical connection component may occur.

The particle diameter of the inorganic filler is the equivalent spherical diameter (diameter). The particle size of the inorganic filler is measured by a laser diffraction method. For the measurement of the particle size, a solvent in which the particles are well dispersed without precipitation or aggregation of the particles is appropriately selected. When the particles are silica, the solvent is, for example, water, an alcohol, or a solvent including a surfactant. Further, the particles may be dispersed in a solvent by ultrasonic vibration.

The content of the fibrous inorganic filler in the inorganic filler is preferably less than or equal to 0.01 wt %. Further, it is more preferable that the fibrous inorganic filler is not included in the inorganic filler. The fibrous inorganic filler has a shape with a relatively large aspect ratio and a length of greater than or equal to 10.6 μm. The fibrous inorganic filler cannot be deformed in accordance with expansion and contraction of the surrounding base resin, and the anisotropy of the optical connection component is increased. When the content of the fibrous inorganic filler having a length of greater than or equal to 10.6 μm is less than or equal to 0.01 wt%, the influence of the fibrous inorganic filler can be ignored. The content and the length of the fibrous inorganic filler are the content in the state of the pellet or the optical connection component. Since a part of the fibrous inorganic filler is broken by kneading by a twin-screw kneading extruder described later, the content and length of the fibrous inorganic filler change before and after kneading.

A method for measuring the length of the fibrous inorganic filler will be described. First, the pellet or the optical connection component is completely ashed by heating at 700° C. to prepare a sample. The sample particles are spread on a sample fixing tape so as not to overlap with each other, and the sample is observed at a magnification of 2000 times using a scanning electron microscope. The sample is photographed at randomly selected three locations, and the length of the fibrous inorganic filler in the photographed image is measured.

### [Manufacturing Method]

Next, a method for manufacturing a ferrule using the resin composition will be described. FIG. 2 is a flowchart illustrating a method for manufacturing the ferrule 10 according to the present embodiment.

In step S101, first, a base resin, an inorganic filler, a colorant, a silane coupling agent, and the like are blended. Thereafter, the mixture is stirred by a Henschel mixer or the like, and then kneaded by a twin-screw kneading extruder or the like. Thus, a resin composition is produced.

In step S102, the resin composition is injected into the mold while being heated. After cooling the resin composition, the ferrule 10 is removed from the mold. [Effect]

In the present embodiment, the glass transition temperature of the base resin is higher than or equal to 85° C. The mass of the residue obtained by heating the resin composition at 700° C. (heated residue) is greater than or equal to 68.0% and less than or equal to 74.4% of the mass of the resin composition. Further, the resin composition has a Rockwell hardness of greater than or equal to 97.1 and less than or equal to 106.8. Accordingly, it is possible to provide a resin composition capable of achieving both suppression of loss fluctuation due to temperature increase and favorable PC connection. Hereinafter, the effect of the present embodiment will be described in detail in comparison with the related art.

In an optical connection component such as an MT ferrule, it is required to maintain stable connection characteristics even in a high temperature environment. For example, it is defined in the international standard Telcordia GR-1435-CORE Issue 2 that, under an uncontrolled environment corresponding to an outdoor environment, it is necessary to suppress the fluctuation of the connection loss in the optical connection component in a high temperature environment of 85° C. to less than or equal to 0.30 dB in a standard and high performance grade and to less than or equal to 0.20 dB in an ultra performance grade.

Such a fluctuation in the connection loss is caused by the expansion of the base resin due to the temperature increase and the displacement of the position of the end face of the optical fiber inserted into the optical connection component. As a technique for suppressing the g the fluctuation of the connection loss due to the temperature increase, it is conceivable to add an inorganic filler to the base resin. The resin composition for an optical connection component described in Japanese Patent Application Laid-Open No. 2004-29415 includes 80 to 90% by weight of spherical silica fine particles to reduce the connection loss of the optical connection component due to temperature increase.

However, when the content of the inorganic filler increases, the rigidity of the optical connection component becomes too high, and the connection loss increases. In general, there are manufacturing fluctuation of several micrometers in the guide pin insertion holes of the optical connection components, and the optical connection components are connected to each other by inserting the guide pins into the guide pin insertion holes while the optical connection components are appropriately deformed. At this time, a constant pressure is applied to the rear side of the optical connection component by the spring, and appropriate PC connection between the optical fibers is realized. When the hardness of the optical connecting component is too high, the resistance at the time of insertion of the guide pin increases, and the pressure for pressing the optical fibers decreases. Therefore, the end faces of the optical fibers cannot be sufficiently close to each other, and the PC connection between the optical fibers may be deteriorated. In particular, in the case of a multicore ferrule, Fresnel reflection occurs due to a gap between the end faces of the optical fibers, and the connection loss may greatly fluctuate.

Due to the above background, a resin composition capable of achieving both suppression of loss fluctuation at high temperature and satisfactory PC connection has been desired. As a result of intensive studies, the present inventors have found a resin composition capable of achieving both suppression of loss fluctuation at high temperature and satisfactory PC connection by the following characteristic configuration.

First, the glass transition temperature of the base resin is higher than or equal to 85° C. As a result, the softening of the base resin can be suppressed even in a high temperature environment of 85° C., and the fluctuation of the connection loss of the optical connection component due to the temperature increase can be suppressed.

Secondly, the mass of the residue obtained by heating the resin composition at 700° C. is greater than or equal to 68.0% and less than or equal to 74.4% with respect to the mass of the resin composition. The composition of the resin composition differs before and after kneading. In particular, in engineering plastics and super engineering plastics having a high melting temperature, a polymer material and an inorganic material are generally combined by a twin-screw extruder. When the twin-screw extruder kneads the resin composition, large shearing heat is generated in the kneading portion, and the silane coupling agent of the resin composition, a part of the base resin, or impurities in the resin composition are decomposed or volatilized.

Thirdly, the resin composition has a Rockwell hardness of greater than or equal to 97.1 and less than or equal to 106.8. The Rockwell hardness is adjusted by changing the types and amounts of the base resin, the inorganic filler, the silane coupling agent, and the like.

According to the characteristic configuration described above, it can be confirmed by the following Examples that a resin composition capable of achieving both suppression of loss fluctuation due to temperature increase and favorable PC connection can be provided.

### Example

Next, Examples and Comparative Examples of the present invention will be described. First, components of resin compositions in Examples and Comparative Examples will be described.

### [Table 1]

TABLE 1

| | | Inorganic filler | | | Si- | |
|---|---|---|---|---|---|---|
| | | | | Addi- | lane | |
| | | | | tive | cou- | Calcium |
| | Base | D₁₀₀ | D₅₀ | ratio | pling | car- |
| | resin | [μm] | [μm] | [%] | agent | bonate |
| Example 1 | PPS1 | 128.3 | 26.0 | 69.5 | SC1 | Absence |
| Example 2 | PPS1 | 128.3 | 26.0 | 75.9 | SC1 | Absence |
| Example 3 | PPS1 | 98.4 | 16.0 | 69.5 | SC1 | Absence |
| Example 4 | PPS1 | 98.4 | 16.0 | 75.9 | SC1 | Absence |
| Example 5 | PPS1 | 40.2 | 9.5 | 69.5 | SC1 | Absence |
| Example 6 | PPS1 | 40.2 | 9.5 | 71.1 | SC1 | Absence |
| Example 7 | PPS1 | 40.2 | 9.5 | 75.9 | SC1 | Absence |
| Example 8 | PPS1 | 32.0 | 7.0 | 69.5 | SC1 | Absence |
| Example 9 | PPS1 | 32.0 | 7.0 | 75.9 | SC1 | Absence |
| Example 10 | PPS1 | 20.0 | 5.5 | 69.5 | SC1 | Absence |
| Example 11 | PPS1 | 20.0 | 5.5 | 75.9 | SC1 | Absence |
| Example 12 | PPS1 | 7.1 | 1.4 | 69.5 | SC1 | Absence |
| Example 13 | PPS1 | 7.1 | 1.4 | 71.1 | SC1 | Absence |
| Example 14 | PPS1 | 7.1 | 1.4 | 75.9 | SC1 | Absence |
| Example 15 | PPS2 | 40.2 | 9.5 | 69.5 | SC1 | Absence |
| Example 16 | PPS2 | 40.2 | 9.5 | 75.9 | SC1 | Absence |
| Comparative Example 1 | PPS1 | 128.3 | 26.0 | 65.5 | SC1 | Absence |
| Comparative Example 2 | PPS1 | 128.3 | 26.0 | 67.5 | SC1 | Absence |
| Comparative Example 3 | PPS1 | 128.3 | 26.0 | 77.5 | SC1 | Absence |
| Comparative Example 4 | PPS1 | 98.4 | 16.0 | 65.5 | SC1 | Absence |
| Comparative Example 5 | PPS1 | 98.4 | 16.0 | 67.5 | SC1 | Absence |
| Comparative Example 6 | PPS1 | 98.4 | 16.0 | 77.5 | SC1 | Absence |
| Comparative Example 7 | PPS1 | 40.2 | 9.5 | 65.5 | SC1 | Absence |
| Comparative Example 8 | PPS1 | 40.2 | 9.5 | 67.5 | SC1 | Absence |
| Comparative Example 9 | PPS1 | 40.2 | 9.5 | 77.5 | SC1 | Absence |
| Comparative Example 10 | PPS1 | 32.0 | 7.0 | 65.5 | SC1 | Absence |
| Comparative Example 11 | PPS1 | 32.0 | 7.0 | 67.5 | SC1 | Absence |
| Comparative Example 12 | PPS1 | 32.0 | 7.0 | 77.5 | SC1 | Absence |
| Comparative Example 13 | PPS1 | 20.0 | 5.5 | 65.5 | SC1 | Absence |
| Comparative Example 14 | PPS1 | 20.0 | 5.5 | 67.5 | SC1 | Absence |
| Comparative Example 15 | PPS1 | 20.0 | 5.5 | 77.5 | SC1 | Absence |
| Comparative Example 16 | PPS1 | 7.1 | 1.4 | 65.5 | SC1 | Absence |
| Comparative Example 17 | PPS1 | 7.1 | 1.4 | 67.5 | SC1 | Absence |
| Comparative Example 18 | PPS1 | 7.1 | 1.4 | 77.5 | SC1 | Absence |
| Comparative Example 19 | PPS2 | 40.2 | 9.5 | 65.5 | SC1 | Absence |
| Comparative Example 20 | PPS2 | 40.2 | 9.5 | 67.5 | SC1 | Absence |
| Comparative Example 21 | PPS2 | 40.2 | 9.5 | 77.5 | SC1 | Absence |
| Comparative Example 22 | PPS1 | 40.2 | 9.5 | 69.5 | SC1 | Presence |
| Comparative Example 23 | PPS1 | 40.2 | 9.5 | 75.9 | SC1 | Presence |
| Comparative Example 24 | PPS1 | 40.2 | 9.5 | 69.5 | SC2 | Absence |
| Comparative Example 25 | PPS1 | 40.2 | 9.5 | 75.9 | SC2 | Absence |

Table 1 shows the base resin, the inorganic filler, and the silane coupling agent included in the resin compositions according to Examples and Comparative Examples. Table 1 shows the presence or absence of calcium carbonate in the inorganic filler.

In Examples 1 to 16 and Comparative Examples 1 to 25, the glass transition temperature of the base resin was 89° C., and the content of the base resin was 100 weight parts. “PPS1” represents a linear polyphenylene sulfide resin (DIC Corporation: melt viscosity 17 Pa·s), and “PPS2” represents a semi-linear polyphenylene sulfide resin (DIC Corporation: melt viscosity 30 Pa·s).

The glass transition temperature of the base resin is measured in accordance with JIS K-7121. First, pellets or ferrules are prepared from the resin composition by a method described below. Thereafter, the pellets or ferrules are divided into portions of a size that can enter the measuring machine and are adjusted under standard conditions to produce a sample. Then, the sample is subjected to differential scanning calorimetry (DSC) at a temperature increasing rate of 10° C./min, and the midpoint glass transition temperature is measured as the glass transition temperature.

In accordance with JIS K-7210, the melt viscosity of the base resin is measured under the conditions of a temperature of 300° C., a load of 20 kgf, and a die of 1.0 mm×10 mm.

In Examples 1 to 9, 15, and 16 and Comparative Examples 1 to 12, 19 to 25, the inorganic filler is spherical silica (manufactured by NIPPON STEEL Chemical & Material Co., Ltd.). In Examples 10 and 11 and Comparative Examples 13 to 15, the inorganic filler is spherical silica (manufactured by TATSUMORI). In Examples 12 to 14 and Comparative Examples 16 to 18, the inorganic filler is spherical silica (manufactured by Admatechs).

In Examples 1 to 16 and Comparative Examples 1 to 25, 2 weight parts of furnace black (#7360 manufactured by Tokai Carbon) is added as a colorant.

A method for measuring the cumulative 100% particle diameter D₁₀₀ and the cumulative 50% particle diameter D₅₀ of the inorganic filler will be described. First, a heated residue is obtained by a method described later. Next, the heated residue is finely ground so as not to destroy the inorganic filler, thereby obtaining a sample. Then, the equivalent spherical diameter of the inorganic filler in the sample is measured at wet condition using a laser diffraction particle size distribution analyzer PSA 1190 (manufactured by Anton Paar) to measure a cumulative 100% particle diameter D₁₀₀ and a cumulative 50% particle diameter D₅₀. In the measurement at wet condition, water is used as a solvent, and ultrasonic waves are used in the measurement.

The “additive ratio” of the inorganic filler is expressed as a weight ratio with respect to the entire resin composition.

In Examples 1 to 16 and Comparative Examples 1 to 25, the resin composition was dry-treated with a liquid silane coupling agent. The content of the silane coupling agent is 3 weight parts. “SC1” is a vinyl silane coupling agent (manufactured by Shin-Etsu Chemical Co., Ltd.). “SC2” is an amino-based silane coupling agent (manufactured by Shin-Etsu Chemical Co., Ltd.).

In Comparative Examples 22 and 23, acicular soft calcium carbonate is added to the resin composition (manufactured by MARUO CALCIUM CO., LTD.). In Examples 1 to 16 and Comparative Examples 1 to 21, 24, and 25, calcium carbonate is not added to the resin composition. Calcium carbonate is added so that the weight ratio of silica to calcium carbonate is 8:2. The maximum length, average length, and average diameter of the acicular soft calcium carbonate before kneading the resin composition are 25 μm, 10 μm, and 2 μm, respectively. The maximum length of the acicular soft calcium carbonate after kneading the resin composition is 10.6 μm.

A method for measuring the length of the fibrous inorganic filler will be described. First, a heated residue is obtained by a method described later. The heated residue is observed at a magnification of 2000 times using a scanning electron microscope at randomly selected three positions selected, and the length of particles having a fibrous or needle-like shape is measured.

Next, experimental results of pellets and ferrules manufactured from the resin compositions of Examples and Comparative Examples are as follows. The ferrules in the Example and the Comparative Example are 12-fibers MT ferrules.

TABLE 2

| | Additive | Heated | Rockwell | Loss | | | | |
|---|---|---|---|---|---|---|---|---|
| | ratio [%] | residue [%] | hardness | fluctuation [dB] | Evaluation 1 | Evaluation 2 | Evaluation 3 | Evaluation 4 |
| Example 1 | 69.5 | 68.0 | 98.4 | 0.28 | OK | B | C | OK |
| Example 2 | 75.9 | 74.4 | 105.6 | 0.11 | OK | A | C | OK |
| Example 3 | 69.5 | 68.0 | 97.1 | 0.27 | OK | B | B | OK |
| Example 4 | 75.9 | 74.4 | 104.9 | 0.13 | OK | A | B | OK |
| Example 5 | 69.5 | 68.0 | 97.5 | 0.27 | OK | B | A | OK |
| Example 6 | 71.1 | 69.6 | 100.8 | 0.18 | OK | A | A | OK |
| Example 7 | 75.9 | 74.4 | 105.5 | 0.09 | OK | A | A | OK |
| Example 8 | 69.5 | 68.0 | 97.2 | 0.25 | OK | B | A | OK |
| Example 9 | 75.9 | 74.4 | 106.7 | 0.10 | OK | A | A | OK |
| Example 10 | 69.5 | 68.0 | 99.1 | 0.29 | OK | B | A | OK |
| Example 11 | 75.9 | 74.4 | 106.8 | 0.11 | OK | A | A | OK |
| Example 12 | 69.5 | 68.0 | 98.8 | 0.29 | OK | B | A | OK |
| Example 13 | 71.1 | 69.6 | 100.3 | 0.19 | OK | A | A | OK |
| Example 14 | 75.9 | 74.4 | 106.3 | 0.10 | OK | A | A | OK |
| Example 15 | 69.5 | 68.0 | 97.1 | 0.29 | OK | B | A | OK |
| Example 16 | 75.9 | 74.4 | 105.1 | 0.10 | OK | A | A | OK |
| Comparative Example 1 | 65.5 | 64.0 | 95.1 | 0.55 | OK | C | B | OK |
| Comparative Example 2 | 67.5 | 66.0 | 96.3 | 0.50 | OK | C | B | OK |
| Comparative Example 3 | 77.5 | 76.0 | 106.9 | — | NG | — | C | OK |
| Comparative Example 4 | 65.5 | 64.0 | 95.0 | 0.56 | OK | C | A | OK |
| Comparative Example 5 | 67.5 | 66.0 | 96.5 | 0.49 | OK | C | B | OK |
| Comparative Example 6 | 77.5 | 76.0 | 106.7 | — | NG | — | C | OK |
| Comparative Example 7 | 65.5 | 64.0 | 95.7 | 0.53 | OK | C | A | OK |
| Comparative Example 8 | 67.5 | 66.0 | 96.5 | 0.47 | OK | C | A | OK |
| Comparative Example 9 | 77.5 | 76.0 | 107.1 | — | NG | — | B | OK |
| Comparative Example 10 | 65.5 | 64.0 | 96.1 | 0.57 | OK | C | A | OK |
| Comparative Example 11 | 67.5 | 66.0 | 97.0 | 0.52 | OK | C | A | OK |
| Comparative Example 12 | 77.5 | 76.0 | 107.3 | — | NG | — | B | OK |
| Comparative Example 13 | 65.5 | 64.0 | 95.5 | 0.55 | OK | C | A | OK |
| Comparative Example 14 | 67.5 | 66.0 | 97.3 | 0.51 | OK | C | A | OK |
| Comparative Example 15 | 77.5 | 76.0 | 107.5 | — | NG | — | B | OK |
| Comparative Example 16 | 65.5 | 64.0 | 96.3 | 0.54 | OK | C | A | OK |
| Comparative Example 17 | 67.5 | 66.0 | 97.6 | 0.48 | OK | C | A | OK |
| Comparative Example 18 | 77.5 | 76.0 | 106.8 | — | NG | — | A | NG |
| Comparative Example 19 | 65.5 | 64.0 | 94.9 | 0.55 | OK | C | A | OK |
| Comparative Example 20 | 67.5 | 66.0 | 96.0 | 0.49 | OK | C | A | OK |
| Comparative Example 21 | 77.5 | 76.0 | 107.0 | — | NG | — | B | OK |
| Comparative Example 22 | 69.5 | 68.0 | 94.3 | 0.44 | OK | C | A | OK |
| Comparative Example 23 | 75.9 | 74.4 | 96.5 | 0.39 | OK | C | A | OK |
| Comparative Example 24 | 69.5 | 68.0 | 94.8 | 0.42 | OK | C | A | OK |
| Comparative Example 25 | 75.9 | 74.4 | 96.9 | 0.38 | OK | C | A | OK |

Table 2 shows the additive ratio of the inorganic filler, the heated residues of the pellets and ferrules, the Rockwell hardness of the pellets and ferrules, the fluctuation of the connection loss of the pellets and ferrules due to the temperature increase, the evaluation of the PC connection of the pellets and ferrules (Evaluation 1), the evaluation of the fluctuation of the connection loss due to the temperature increase (Evaluation 2), the evaluation of the abrasiveness (Evaluation 3), and the evaluation of the appearance (Evaluation 4) of the pellets and ferrules.

A method for manufacturing pellets and ferrules according to Examples and Comparative Examples will be described. First, the components shown in Table 1 are mixed, and then the resin composition is kneaded by a twin-screw extruder at 350° C. and a screw rotation speed of 400 rpm to prepare pellets. Thereafter, the pellets are injection-molded by an electric injection molding machine at a cylinder temperature of 320° C. to 350° C., a mold temperature of 130° C. to 160° C., and a holding pressure of 1000 to 1500 kgf/cm2 to produce a 12-fibers MT ferrule. The ferrule is manufactured so that the diameter of the guide hole is 699.0 to 699.4 μm. Further, the length of a perpendicular line extending from the center of the fiber insertion hole to the center axis of the guide pin insertion hole is adjusted to be 0 to 0.5 μm, and at least one fiber insertion hole is adjusted to be 0.45 to 0.5 μm.

A method for measuring the heated residue will be described. First, 3 mg of a sample obtained by crushing pellets or ferrules is prepared. The sample is heated from room temperature to 700° C. at a temperature increasing rate of 10° C./min in an oxygen flow at a flow rate of 200 ml/min by a thermogravimetric analyzer (manufactured by METTLER TOLEDO). Each Example and Comparative example is tested 5 times. Then, an average value of values obtained by dividing the weight at 700° C. by the weight at room temperature is calculated as a heated residue.

Next, a method for measuring the Rockwell hardness will be described. First, a pellet or ferrule is compression molded at a temperature of 350° C. and a pressure of 1 MPa to prepare a test piece of 4 mm×10 mm×80 mm. The molding temperature is preferably higher than or equal to 300° C. and lower than or equal to 400° C., and the pressure at the time of compression molding is preferably higher than or equal to contact pressure of press and lower than or equal to 10 MPa. A vacuum draw is used as necessary to adjust the pressure. Next, based on JIS 7202-2, the indenter is pressed against the center of the 10 mm×80 mm surface of the test piece and two points of about 10 mm from the center and two points of about 20 mm from the center on both sides in the long side direction of the test piece under the conditions of a hardness scale M, a reference load of 98.07 N, a test load of 980.7 N, and a steel ball indenter of 6.35 mm at room temperature, and an average value thereof is calculated. At the time of the test, the test piece is pressed in such a manner that no mark is formed on the surface opposite to the surface on which the test piece is provided. Before compression molding, the ferrule is crushed using a hammer with a force that does not change the shape of the inorganic filler. At this time, care is taken not to crush so finely that the shape of the inorganic filler changes. The compression molding is performed so that no air bubbles having a diameter of greater than or equal to 1 mm exist inside the test piece. The bubble is confirmed by observing the inside of the test piece using X-ray CT.

Next, a method for measuring the loss fluctuation will be described. First, 15 pairs of MPO connectors are assembled using ferrules of Examples and Comparative Examples. Next, 12 optical fibers are connected to each MPO connector, placed in a thermostatic chamber, and the connection losses of 180 optical fibers are measured. First, the connection loss when the temperature of the thermostatic chamber is room temperature is measured. Next, the temperature of the thermostatic chamber is raised to 85° C., the temperature is maintained for 168 hours, and the maximum connection loss during that time is measured. The difference between the maximum connection loss at 85° C. and the connection loss at room temperature is calculated as the loss fluctuation. The measurement wavelength of the connection loss is 1.31 μm.

In the connection loss at room temperature, when the connection loss of all of the 180 optical fibers is less than 1 dB, Evaluation 1 is evaluated as good (OK). When the connection loss of one or more optical fibers among the 180 optical fibers is greater than or equal to 1 dB, the Evaluation 1 is evaluated as poor (NG).

When the loss fluctuation in Table 2 is greater than or equal to 0 dB and less than 0.2 dB, Evaluation 2 is evaluated as good (A). When the loss fluctuation in Table 2 is greater than or equal to 0.2 dB and less than 0.3 dB, Evaluation 2 is evaluated as good (B). When the loss fluctuation in Table 2 is greater than or equal to 0.3 dB, Evaluation 2 is evaluated as poor (C). When Evaluation 1 is poor (NG), Evaluation 2 is omitted.

The evaluation method of Evaluation 3 will be described. First, 12 optical fibers are inserted into a ferrule, and the optical fibers are fixed with an epoxy resin adhesive. Next, the optical fiber protruding from the end face of the ferrule and the epoxy resin adhesive adhering to the end face of the ferrule are removed with water-resistant abrasive paper No. 2000 coated with silicon carbide abrasive grains. Thereafter, water is dropped onto the lapping film coated with silicon carbide abrasive grains of 15 μm, and the ferrule is polished for 1 minute using an MT ferrule polishing apparatus (manufactured by Domaille). Then, water is dropped onto the lapping film coated with silicon carbide grains of 3 μm, and the polishing time until the average protruding length of the 12 fibers became 2 μm is measured. When the polishing time is less than 1 minute, Evaluation 3 is evaluated as good (A). When the polishing time is greater than or equal to 1 minute and less than or equal to 2 minutes, Evaluation 3 is evaluated as good (B). When the polishing time is greater than or equal to 2 minutes, Evaluation 3 is evaluated as poor (C).

The appearance of the ferrule is observed and when there is no sink mark or unfilled in the ferrule, Evaluation 4 is evaluated as good (OK). When there is sink mark or unfilled in the ferrule, Evaluation 4 is evaluated as poor (NG).

As described above, according to the present invention, it is possible to provide an optical connection component capable of achieving both suppression of loss fluctuation due to temperature increase and satisfactory PC connection.

When the content of the inorganic filler increases, the hardness of the optical connection component also increases, and the polishing efficiency of the optical connection component decreases. Therefore, it may be difficult to achieve both suppression of loss fluctuation due to temperature increase and improvement of polishing efficiency. In the present invention, the cumulative 100% particle diameter D₁₀₀ of the inorganic filler is preferably less than or equal to 98.4 μm. The cumulative 100% particle diameter D₁₀₀ of the inorganic filler is preferably less than or equal to 40.2 μm. This makes it possible to obtain a resin composition having improved polishing efficiency in addition to achieving both suppression of loss fluctuation due to temperature increase and satisfactory PC connection.

The present invention is not limited to the above-described embodiment, and various modifications are possible. In addition, well-known techniques and publicly known techniques in the technical field can be appropriately applied to portions which are not particularly described or illustrated in the embodiments. For example, although the diameter of the guide pin insertion hole of the ferrule in the Embodiment and the Comparative Example is 700 μm, the same result can be obtained in the case where the guide pin insertion hole is 550 μm or another size. Further, although the ferrules in the Embodiment and the Comparative Example are 12-fiber MT ferrules, the same result can be obtained also in the case of a ferrule having a plurality of fiber hole position arrays of 12-fiber×2 rows. Further, the present invention can be applied not only to an MT ferrule having a normal size but also to an optical connection component having a positioning principle similar to that of the MT ferrule.

What is claimed is:

1. A resin composition for an optical connection component comprising:
a base resin; and
an inorganic filler,
wherein a glass transition temperature of the base resin is higher than or equal to 85° C.,
wherein a mass of a residue obtained by heating the resin composition for the optical connection component at 700° C. is greater than or equal to 68.0% and less than or equal to 74.4% with respect to a mass of the resin composition for the optical connection component, and
wherein a Rockwell hardness of the resin composition for the optical connection component is greater than or equal to 97.1 and less than or equal to 106.8.

2. The resin composition for the optical connection component according to claim 1, wherein the base resin is a thermoplastic crystalline polymer.

3. The resin composition for the optical connection component according to claim 1, wherein the base resin is a polyarylene sulfide.

4. The resin composition for the optical connection component according to claim 1, wherein the base resin is polyphenylene sulfide.

5. The resin composition according to claim 1, wherein the inorganic filler is silica.

6. The resin composition for the optical connection component according to claim 1, wherein a cumulative 100% particle diameter D₁₀₀ of the inorganic filler is less than or equal to 98.4 μm.

7. The resin composition for the optical connection component according to claim 1, wherein a cumulative 100% particle diameter D₁₀₀ of the inorganic filler is less than or equal to 40.2 μm.

8. The resin composition for the optical connection component according to claim 1, wherein a content of silica in the inorganic filler is greater than or equal to 99.99 wt %.

9. The resin composition for the optical connection component according to claim 1, wherein a content of the fibrous inorganic filler having a length of greater than or equal to 10.6 μm in the inorganic filler is less than or equal to 0.01 wt %.

10. An MT ferrule comprising the resin composition for the optical connection component according to claim 1.

11. A method for manufacturing a resin composition for an optical connection component comprising:
a first step for mixing a base resin and an inorganic filler; and
a second step for injection-molding a mixture obtained in the first step,
wherein a glass transition temperature of the base resin is higher than or equal to 85° C.,
wherein a mass of a residue obtained by heating the resin composition for the optical connection component at 700° C. is greater than or equal to 68.0% and less than or equal to 74.4% with respect to a mass of the resin composition for the optical connection component, and
wherein a Rockwell hardness of the resin composition for the optical connection component is greater than or equal to 97.1 and less than or equal to 106.8.
